(19) United States
(12) Patent Application Publication
(10) Pub. No.: US 2023/0377071 A1
(43) Pub. Date: Nov. 23, 2023

(54) VERIFIABLE PROPERTY RECORD USING A DISTRIBUTED ELECTRONIC LEDGER

(71) Applicant: Thumbtack, Inc., San Francisco, CA (US)

(72) Inventors: Ambles KWOK, Richmond Hill (CA); David STECKEL, Toronto (CA); Adam JACKSON, Loganville, GA (US); Jesse STAUFFER, Flower Mound, TX (US); James PORCELLI, New York, NY (US)

(21) Appl. No.: 17/746,749

(22) Filed: May 17, 2022

(51) Int. Cl. G06Q 50/16

(52) U.S. Cl. CPC G06Q 50/163

(57) ABSTRACT

A verifiable property record of a property using a distributed electronic ledger. A request is received to add an item to the distributed electronic ledger, where the item is related to the property. A determination is made whether the item is authorized to be added to the distributed electronic ledger including determining whether the source of the request is permitted to write to the distributed electronic ledger. The source of the request may be permitted to write to the distributed electronic ledger if the source has explicit permission or has satisfied one or more verification criteria. If the item is authorized to be added to the distributed electronic ledger, the item is written to the distributed electronic ledger.

### FIELD

Embodiments of the invention relate to the field of record management; and more specifically, to a verifiable property record using a distributed electronic ledger.

### BACKGROUND

Keeping track of property maintenance, repair, and improvements is a daunting task for property owners. For instance, some property owners may not have all the necessary details of the job performed. Further, the records can easily be misplaced or stored in multiple areas. Even if one were to create a comprehensive property record, it is seldom passed on to the next property owner. Even if the record is passed, these records can be easily forged. And for most properties, there is no historical record of past maintenance, repairs, upgrades, or the businesses/individuals that completed these tasks. This historical data is invaluable for both potential homeowners who are trying to identify whether a home has been properly maintained over the years, as well as new/current homeowners who seek to continue proper maintenance of their home in the years to come.

### SUMMARY

A verifiable property record using a distributed electronic ledger is described. A method is described including receiving a first request to add a first item to a distributed electronic ledger, where the first item is related to the property; determining that the first item is authorized to be added to the distributed electronic ledger including: determining a first source of the first request to add the first item to the distributed electronic ledger, and determining that the first source of the first request has explicit permission to write to the distributed electronic ledger. The method also includes responsive to determining that the first item is authorized to be added to the distributed electronic ledger, causing the first item to be added to the distributed electronic ledger; receiving a second request to add a second item to the distributed electronic ledger, the second item related to the property; determining that the second item is authorized to be added to the distributed electronic ledger including: determining a second source of the second request to add the second item to the distributed electronic ledger, determining that the second source of the second request does not have explicit permission to write to the distributed electronic ledger, and determining that the second source of the second request has satisfied one or more verification criteria for adding the second item to the distributed electronic ledger. The method also includes responsive to determining that the second item is authorized to be added to the distributed electronic ledger, causing the second item to be added to the distributed electronic ledger. Other embodiments of this aspect include corresponding computer systems, apparatus, and computer programs stored on non-transitory machine-readable media.

### BRIEF DESCRIPTION OF THE DRAWINGS

The invention may best be understood by referring to the following description and accompanying drawings that are used to illustrate embodiments of the invention. In the drawings:

FIG. 1 is a block diagram that illustrates an exemplary system for a verifiable property record of a property using a distributed electronic ledger according to an embodiment.

FIG. 2 is a flow diagram that illustrates exemplary operations for a verifiable property record of a property using a distributed electronic ledger according to an embodiment.

FIG. 3 is a flow diagram that illustrates exemplary operations for determining whether an item is authorized to be added to a property record of a distributed electronic ledger according to an embodiment.

FIG. 4 is a block diagram illustrating a data processing system that can be used in an embodiment.

### DESCRIPTION OF EMBODIMENTS

A verifiable property record using a distributed electronic ledger is described. The property record is associated with a physical property (e.g., residential property, commercial property, industrial property, agricultural property, etc.) and includes information related to the property including maintenance performed to the property. The property record is stored using a distributed electronic ledger (e.g., a blockchain) that is an immutable record. The distributed electronic ledger system provides a way to verify the transactions thereby creating a non-repudiation record of the information. The property record may be passed on from one property owner to another.

An item related to the property is requested to be added to the distributed electronic ledger. The item may include a record of service completed for the property (e.g., maintenance job performed, installation of a product, an addition to the property, work permit requested or received). The item may include one or more features of the property (e.g., lot size, year built, stories, number of rooms, number of bathrooms, air conditioning type, heating type, roof type, number of fireplaces, square footage, etc.). The item may include financial information of the property (e.g., date sold, amount paid, property tax paid, etc.). The item may include information about the owner of the property (e.g, name of the entity that owns the property, ownership change date, latest purchase price, sale listing price, etc.). The item may include area information to which the property belongs (e.g., crime scores in the area, demographic information of the area). The item may include area information about the vendor who performed a given task at the property (e.g., Alair homes completed the kitchen renovation).

The information included in the item depends on the type of event. For instance, an item related to a service completed for the property may include one or more of the following: a name of the service provider, a public address of the service provider, a completion date, a category of service provided, a location where the service was provided (e.g., street address, city, state, zip code), notes about the service provided, the name and/or make of any products installed or repaired, warranty information of any products installed, serial number of any products installed, what materials were used for the service, and any other information the service provider and/or service buyer would like to include.

The item may include an identity of the entity that is requesting the item be written to the property record on the distributed electronic ledger and/or causing the request for the item to be written to the property record. The entity making the request is sometimes referred herein as the requester. The requester may include the owner of the property, the manager of the property, a service provider that provided a service for the property (e.g., maintenance performed, repair performed, improvement performed, selling the property), a representative of a government entity, or a system generated requester.

The request to add the item to the distributed electronic ledger may be made in multiple ways in an embodiment. As an example, the request submission may integrate with an online service marketplace that allows a service buyer to locate and/or hire service providers for a service for the property. The online service marketplace may store information about services requested and/or provided for the property (e.g., a name of the service provider, a public address of the service provider, a completion date, a category of service provided, a location where the service was provided (e.g., street address, city, state, zip code), notes about the service provided, the name and/or make of any products installed or repaired, warranty information of any products installed, serial number of any products installed, what materials were used for the service, and the cost of the service). If the service was obtained through the online service marketplace, the requester may use the online service marketplace to indicate that the service was complete and/or cause the service to be written to the distributed electronic ledger. For example, the online service marketplace may provide an interface for the requester to submit a request for the service to be written to the property record. The online service marketplace may include the information known about the property and in some embodiments, the requester can add information to the request and/or remove information from the request (e.g., remove the cost of the service).

As another example, the request to add the item to the distributed electronic ledger may be automatically by a system generated requester. For example, the online service marketplace may automatically generate a request to add an item to the distributed electronic ledger based on an event occurring on the marketplace that represents a completed service for the property associated with the property record. As another example, an application programming interface (API) may be exposed that allows an external party (e.g., an online service marketplace that is not integrated with the distributed electronic ledger manager service) to add items to the distributed electronic ledger.

As another example, the requester may transmit the request to the system through an email or other electronic message. The email or other electronic message may include the scope of the service provided and/or an invoice of the scope of the service. As another example, the requester may provide access to an email account of the requester and the system may automatically scrape the email to locate items to add to the distributed electronic ledger. As another example, the requester may use an application programming interface (API) provided by the system to transmit the request to add an item to the distributed electronic ledger.

In an embodiment, after receiving a request to add an item to the distributed electronic ledger, the system verifies whether the item is authorized to be added to the distributed electronic ledger. Verifying whether the item is authorized to be added to the distributed electronic ledger includes determining whether the entity making the request (e.g., the requester) is authorized to add the item to the distributed electronic ledger and/or determining whether the content of the item has been verified as accurate. Determining whether the entity making the request is authorized to add the item to the distributed electronic ledger may include accessing write permissions for the property record. Write permissions for the property record may be included on the distributed electronic ledger itself. The system may determine these write permissions and determine whether the requester has permission according to these write permissions.

In an embodiment, determining whether the item is authorized to be added to the property record includes determining whether the content of the item has been verified as accurate. In an embodiment, if the content of an item cannot be verified as accurate, the item is not added to the property record. In another embodiment, if the content of an item cannot be verified as accurate, the item may be added to the property record but marked as unverified. Verified items may be marked on the property record as being verified (e.g., the item may have a ‘verified’ field that specifies the verification status of the item).

Verifying the content of the item may take different forms depending on the content of the item that is being requested to be added to the property record. Example verification techniques may include determining proof of payment, determining whether there is consensus between a service buyer and a service provider, and verifying model numbers of products.

The request itself may include information that can be used for verification. For example, if the item requested to be added is for a service performed on the property (e.g., maintenance job performed, installation of a product, an addition to the property, work permit requested or received, etc.), the request may include information that can be used to verify that the service was performed. For instance, the request may include an invoice, a proof of payment, and/or a photo of the completed service that may be used to verify that the service was performed. In an embodiment, if there is a discrepancy between the information in the request and the verification information, the requester is notified and may submit an updated request or provide further information.

With respect to an image, the provided image may be processed to determine the likelihood of whether the information represented in the request is accurate. Processing the provided image may include performing image recognition on the provided photo to determine a likelihood that the provided image matches the information represented in the request. For instance, if the item requested to be added to the distributed electronic ledger represents the installation of a product such as a dishwasher, the provided image may be processed to determine whether that image is of a new dishwasher. If the request includes information regarding a model of the product, the image may be processed to determine the model number and verify the correctness of the product model. Processing the provided image may include analyzing metadata associated with the image (e.g., date, time, and/or location of the image). For instance, if the item requested to be added is for a service performed on a particular property and an image of the completed service is provided, the metadata associated with the image should be consistent with the date, time, and/or location of the completed service.

With respect to an invoice that is provided, the invoice may be processed to verify the amount included in the request matches the amount provided on the invoice. For instance, optical character recognition (OCR) may be performed on the provided invoice (if in image form) to determine the amount and used to match the amount included in the request.

The content of the item may be verified as accurate through information external to the request. For example, if integrated with an online service marketplace that allows service buyers to leave reviews for service provider, the online service marketplace may indicate whether a review was made by the service buyer for the service buyer for service associated with the item (typically such a review is completed after the service has been provided). If the item in question represents a service completed for the property or a product purchased for the property, verifying that the item is accurate may include determining that a positive confirmation of the accuracy of the service or product has been received from a third party (e.g., the service provider or the seller of the product, for example).

If the item is authorized to be added to the distributed electronic ledger, the system causes the item to be added to the distributed electronic ledger. For example, the system may submit the item to be added to the distributed electronic ledger as a transaction, and transaction validators in a validator network agree to write the transaction to the ledger. The specific way in which the item is added depends on the type of distributed electronic ledger. If the item is not authorized to be added to the distributed electronic ledger, then in one embodiment the item is not added to the distributed electronic ledger while in another embodiment the item is added to the distributed electronic ledger but marked as not being authorized.

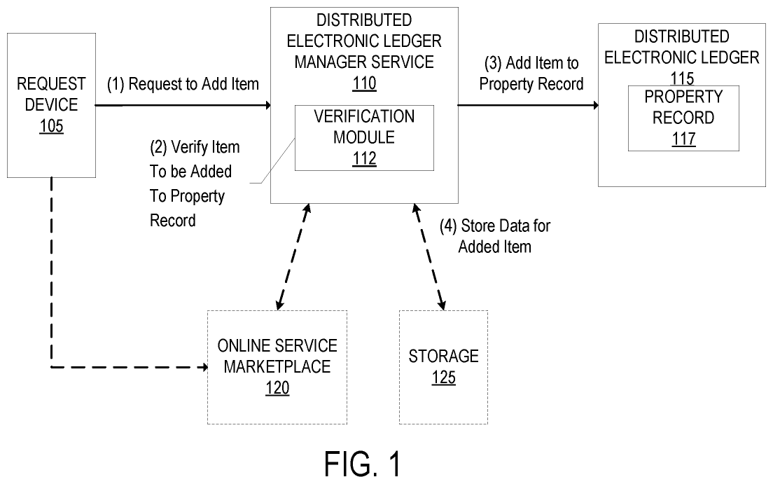

FIG. 1 is a block diagram that illustrates an exemplary system for a verifiable property record of a property using a distributed electronic ledger according to an embodiment. The system included in FIG. 1 includes the request device 105, the distributed electronic ledger manager service 110, the distributed electronic ledger 115, the online service marketplace 120, and the storage 125.

The distributed electronic ledger manager service 110 manages access to the property record 117 of the distributed electronic ledger 115. The distributed electronic ledger 115 may be a blockchain. The property record 117 is a verifiable property record of a physical property (e.g., residential property, commercial property, industrial property, agricultural property, etc.) stored on the distributed electronic ledger 115. The property record 117 is associated with the physical property. The property record 117 may be owned by the owner of the property or its designate. The ownership of the property record may be passed from one property owner (or designate) to another. The property record 117 can include records for service completed for the property (e.g., maintenance job performed, installation of a product, an addition to the property, work permit requested or received, vendor that performed the work), information about features of the property (e.g., lot size, year built, stories, number of rooms, number of bathrooms, air conditioning type, heating type, roof type, number of fireplaces, square footage, etc.), information about financial information of the property (e.g., date sold, amount paid, property tax paid, etc.), information about the ownership of the property (name of the entity that owns the property, ownership change date, latest purchase price, sale listing price, etc.), information about the location of the property (e.g., street address, city, state, zip code, country), and/or information about the area in which the property is located (e.g., crime scores in the area, demographic information of the area).

The property record 117 may be represented as a smart contract that is tied to a physical property (e.g., a street address of the property, a unique identifier of the property) and items are non-fungible tokens (NFTs). The property would “own” the NFTs for all items related to the physical property.

In an embodiment, the property record 117 is created by the distributed electronic ledger manager service 110 and associated with an owner (e.g., the owner of the property associated with the property record 117). As an example, the owner of the property may have a verified account with the online service marketplace 120 and/or the distributed electronic ledger manager service 110 and has proven that they are the owner of the property (e.g., a copy of the deed and identification has been provided, a copy of property tax records for the property and identification has been provided). The distributed electronic ledger manager service 110 may create the property record 117 as a smart contract and the property may “own” the NFTs for all items related to the physical property.

The distributed electronic ledger manager service 110 receives requests from entities to add items to the property record 117 of the distributed electronic ledger 115. These entities, referred sometimes herein as requesters, may or may not be an owner of the property record 117. As an example, a requester can include the owner of the property, a manager of the property, a service provider that provided a service for the property, a representative of a government entity, or a system generated requester. The requests can be received at the distributed electronic ledger manager service 110 in one or more ways including receiving a request through an API, receiving a request through an integration with an online service marketplace, and receiving a request through an electronic message such as email. In the example of FIG. 1, the distributed electronic ledger manager service 110 receives a request to add an item to the property record 117 of the distributed electronic ledger 115 from the request device 105.

As previously described, in an embodiment the request submission may integrate with an online service marketplace. For instance, the online service marketplace 120 allows a service buyer to locate and/or hire service providers for services, including services for the property associated with the property record 117. If a service is obtained through the online service marketplace 120, the requester may use the online service marketplace 120 to indicate that the service was complete and/or cause the service to be written to the property record 117. For example, the online service marketplace 120 may provide an interface for the requester to submit a request for the service to be written to the property record 117. The online service marketplace may include the information known about the property and in some embodiments, the requester can add information to the request and/or remove information from the request (e.g., remove the cost of the service).

In an embodiment, the request may be automatically generated by a system generated requester. For example, a system generated requester may be the online service marketplace 120. The online service marketplace 120 may generate a request automatically based on an event occurring on the platform that represents a completed service for the property associated with the property record 117. For instance, a signal that a service for the property has been completed may be a review of the service professional that was added by the service buyer (typically such a review is completed after the service has been provided). In such a case, the online service marketplace 120 may generate the request automatically responsive to a review being left for the service provider by the service buyer. As another example, a signal that a service for the property has been completed may be positive confirmation from the service provider (e.g., also potentially with a picture of the completed service) and/or the service buyer. In such a case, the online service marketplace 120 may generate the request automatically responsive to receiving positive confirmation from the service provider and/or the service buyer. The online service marketplace 120 may automatically include the information known about the provided service and in some embodiments, the online service marketplace 120 may prompt the owner or manager of the property record 117 to add information and/or remove information from the item to be added to the property record 117.

In an embodiment, the distributed electronic ledger manager service 110 (e.g., the verification module 112) verifies whether the item is authorized to be added to the distributed electronic ledger. Verifying whether the item is authorized to be added to the distributed electronic ledger includes the verification module 112 determining whether the entity making the request (e.g., the requester) is authorized to add the item to the property record 117 of the distributed electronic ledger 115 and/or determining whether the content of the item has been verified as accurate. The owner of the property record 117 is authorized to write items to the property record 117. The owner of the property record 117 may grant permissions to another entity (e.g., another user, an organization, an online service marketplace) including reading and/or write permissions. The online service marketplace 120 and/or the distributed electronic ledger manager service 110 may have permission to write to the property record 117.

Permissions for the property record 117 (e.g., read permission, write permissions, etc.) may be included on the property record 117. In other cases, the distributed electronic ledger manager service 110 may store permissions. In either case, the distributed electronic ledger manager service 110 accesses the permissions and determines whether the identified requester has permission to write the item to the property record 117. If the requester is authorized to add the item, the distributed electronic ledger manager service 110 causes the item to be added to the property record 117 of the distributed electronic ledger 115. As illustrated in FIG. 1, at operation 3, the distributed electronic ledger manager service 110 adds the item to the property record 117 of the distributed electronic ledger 115.

In an embodiment, prior to adding the item to the property record 117, the distributed electronic ledger manager service 110 verifies whether the content of the item is accurate (e.g., is what it is claiming to be). In an embodiment, if the content of an item cannot be verified as accurate, the distributed electronic ledger manager service 110 does not add the item to the property record 117. In another embodiment, if the content of an item cannot be verified as accurate, the distributed electronic ledger manager service 110 adds the item to the property record 117 but marks it as unverified. For example, the item may have a ‘verified’ field that specifies the verification status of the item.

The request itself may include information that can be used for verification. For example, if the item requested to be added is for a service performed on the property (e.g., maintenance job performed, installation of a product, an addition to the property, work permit requested or received, etc.), the request may include information that can be used to verify that the service was performed. For instance, the request may include an invoice, a proof of payment, and/or a photo of the completed service that may be used to verify that the service was performed. In an embodiment, if there is a discrepancy between the information in the request and the verification information, the requester is notified and may submit an updated request or provide further information.

With respect to an image, the provided image may be processed to determine the likelihood of whether the information represented in the request is accurate. Processing the provided image may include the distributed electronic ledger manager service 110 performing image recognition on the provided photo to determine a likelihood that the provided image matches the information represented in the request. For instance, if the item requested to be added to the distributed electronic ledger represents the installation of a product such as a dishwasher, the provided image may be processed to determine whether that image is of a new dishwasher. If the request includes information regarding a model of the product, the image may be processed to determine the model number and verify the correctness of the product model. Processing the provided image may include the distributed electronic ledger manager service 110 analyzing metadata associated with the image (e.g., date, time, and/or location of the image). For instance, if the item requested to be added is for a service performed on a particular property and an image of the completed service is provided, the metadata associated with the image should be consistent with the date, time, and/or location of the completed service.

With respect to an invoice that is provided, the invoice may be processed to verify the amount included in the request matches the amount provided on the invoice. For instance, the distributed electronic ledger manager service 110 may OCR the invoice (if in image form) to determine the amount and used to match the amount included in the request.

The content of the item may be verified as accurate through information external to the request. For example, if integrated with an online service marketplace that allows service buyers to leave reviews for service provider, the online service marketplace may indicate whether a review was made by the service buyer for the service buyer for service associated with the item (typically such a review is completed after the service has been provided). If the item in question represents a service completed for the property or a product purchased for the property, verifying that the item is accurate may include determining that a positive confirmation of the accuracy of the service or product has been received from a third party (e.g., the service provider or the seller of the product, for example).

In an embodiment, the data for the item is stored on-chain; meaning that the data for the item is included on the property record 117. In another embodiment, the data for the item is stored off-chain. For example, the item included on the property record 117 includes a reference (e.g., a URL) to the data stored on an external server. In the example of FIG. 1, the distributed electronic ledger manager service 110 stores data for the item on the storage 125 at operation 4. The data for the item can be addressed in multiple ways. For instance, a unique content identifier (CID) may be generated from the data (e.g., a cryptographic hash of the data) and used to create a URI address for the data stored on the storage 125. Using a CID allows for verifying that the data itself was not modified being linked to the property record 117 (e.g., by using the same cryptographic hash algorithm and comparing the resulting hash against the CID). As another example, the data for the item can be addressed using a conventional URL that is not generated based on the data. Although FIG. 1 shows operation 3 and operation 4, the order of the operations may be switched. Thus, the data for the item may be stored off-chain (e.g., a reference generated for the data and the data being located at that reference) prior to the item that includes that reference being written to the property record 117.

In an embodiment, prior to writing an item to the property record 117, the distributed electronic ledger manager service 110 determines whether that item is duplicative of a previous item on the property record 117. For instance, it is possible that an authorized service provider and a service buyer may both submit the same item to be written to the property record 117. The distributed electronic ledger manager service 110 performs a similarity-based matching to determine whether an existing item on the property record 117 is the same as the item that is currently being requested to be added to the property record 117. The similarity may be based on one or more fields such as the date, identifier of the service provider, identifier of category, and cost. If the distributed electronic ledger manage service 110 determines that it is likely (e.g., above a threshold) that the requested item is duplicative of a previous item, the distributed electronic ledger manager service 110 may notify the requester that the item appears to be on the property record 117. The notification may allow the requester to override the notification and cause the item to be written to the property record 117.

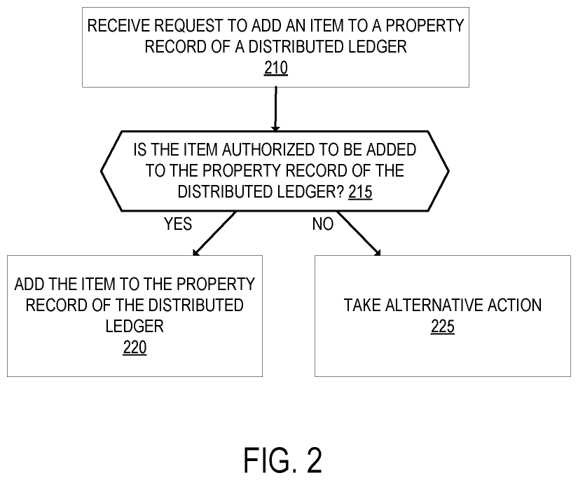

FIG. 2 is a flow diagram that illustrates exemplary operations for a verifiable property record of a property using a distributed electronic ledger according to an embodiment. The operations of FIG. 2 are described with respect to the exemplary embodiment of FIG. 1. However, the operations of FIG. 2 can be performed by different embodiments from that of FIG. 1, and the embodiment of FIG. 1 can perform different operations from that of FIG. 2.

At operation 210, the distributed electronic ledger manager service 110 receives a request to add an item to the property record 117. The item is related to the property associated with the property record 117. As an example, the item may include a record of a service completed for the property (e.g., maintenance job performed, installation of a product, an addition to the property, work permit requested or received). The item may include one or more features of the property (e.g., lot size, year built, stories, number of rooms, number of bathrooms, air conditioning type, heating type, roof type, number of fireplaces, square footage, etc.). The item may include financial information of the property (e.g., date sold, amount paid, property tax paid, etc.). The item may include information about the owner of the property (e.g., name of the entity that owns the property, ownership change date, latest purchase price, sale listing price, etc.). The item may include area information to which the property belongs (e.g., crime scores in the area, demographic information of the area).

The request is received directly or indirectly from a requester. The requester may be an owner of the property, a manager of the property, a service provider that provided a service for the property (e.g., maintenance performed, repair performed, improvement performed, selling the property), a representative of a government entity, or a system generated requester. The request may identify the requester and the target of the request (e.g., an identifier of the property record 117 such as a contract address).

The request can be communicated to the distributed electronic ledger manager service 110 in a number of ways. In one example, the requester can transmit the request through email or other electronic message. The email or other electronic message may include the scope of the service provided, an invoice of the scope of the service, a photo showing completion of the service, and/or other information. As another example, the requester can use an interface provided by the distributed electronic ledger manager service 110 to upload information of the request. As another example, the request can be communicated through an online service marketplace that allows a service buyer to locate and/or hire service providers for a service for the property (e.g., request that a record of a completed service be added to the distributed electronic ledger).

Next, at operation 215, the distributed electronic ledger manager service 110 determines whether the item is authorized to be added to the property record 117 of the distributed electronic ledger 115. Determining whether the item is authorized to be added to the property record 117 includes determining whether the source of the request is authorized to write to the property record 117. In an embodiment, determining whether the item is authorized to be added to the property record 117 further includes determining whether the content of the item has been verified.

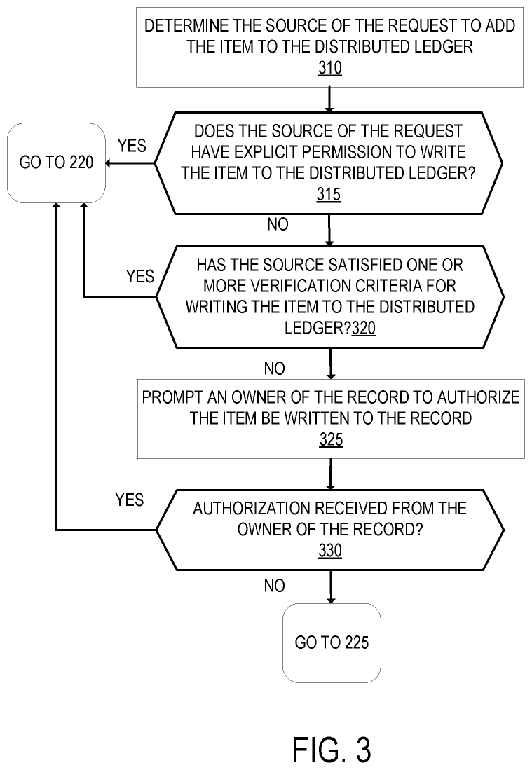

FIG. 3 is a flow diagram that illustrates exemplary operations for determining whether an item is authorized to be added to a property record of a distributed electronic ledger according to an embodiment.

At operation 310, the distributed electronic ledger manager service 110 determines the source of the request to add the item to the distributed electronic ledger. In an embodiment, the request itself identifies the source (e.g., an identifier of the requester such as an account address, an identifier of a system that generates a system generated request). In another embodiment, the distributed electronic ledger manager service 110 determines the source of the request based on the requester being logged into the distributed electronic ledger manager service 110 and/or the online service marketplace 120. In another embodiment, the request is received at an API controlled by the distributed electronic ledger manager service 110. Verified entities may have a verified API key that is included with the request. In such a way, only verified entities have access to write to the distributed electronic ledger.

Next, at operation 315, the distributed electronic ledger manager service 110 determines whether the source of the request has explicit permission to write the item to the property record 117 of the distributed electronic ledger 115. As an example, the owner of the property record 117 may always have permission to write to the property record 117. Write permissions may also be granted to other entities. For example, the online service marketplace 120 and/or the distributed electronic ledger manager service 110 may have explicit permission to write to the property record 117. As another example, the owner of the property record 117 may grant permissions to write to the property record 117. For instance, the online service marketplace 120 and/or the distributed electronic ledger manager service 110 may provide an interface for the owner of the property record 117 to grant write permissions to one or more other entities. The permissions (e.g., read, write, etc.) may be stored on the property record 117 itself. In other cases, the distributed electronic ledger manager service 110 may store permissions. In either case, the distributed electronic ledger manager service 110 accesses the permissions and determines whether the identified requester has permission to write the item to the property record 117. If the requester has permission to write the item to the property record 117, then operation 220 is performed. If the requester does not have explicit permission to write the item to the property record 117, then operation 320 is performed.

At operation 320, the distributed electronic ledger manager service 110 determines whether the source has satisfied one or more verification criteria for writing the item to the property record 117. The verification criteria may indicate that the item in question is legitimate for the property associated with the property record 117. For instance, in the case where the item is a service for the property, the verification criteria may include a statement of work, a receipt or invoice, and a photo for completion. If the source has satisfied the verification criteria, then operation 220 is performed. If the verification criteria is not satisfied, then operation 325 is performed.

At operation 325, the distributed electronic ledger manager service 110 prompts the owner of the property record 117 to provide authorization to write the item to the property record 117. The prompt may be over email, text message, or other electronic ways. The owner may provide the authorization by clicking on an authorization link or button in the electronic message and/or provide the authorization using an interface of the distributed electronic ledger manager service 110 and/or the online service marketplace 120. If authorization is received from the owner of the property record 117 at operation 330, then operation 220 is performed. If authorization is not received from the owner of the property record 117 at operation 330, then operation 225 is performed.

Referring to FIG. 2, at operation 220, the distributed electronic ledger manager service 110 causes the item to be written to the property record 117. At operation 225, where the item is not authorized to be written to the property record 117, an alternative action is taken. In one embodiment, the distributed electronic ledger manager service 110 denies the request and does not write the item to the property record 117. The distributed electronic ledger manager service 110 may cause the requester to be notified that the item is not written to the property record 117. In another embodiment, the distributed electronic ledger manager service 110 writes the item to the property record 117 and marks it as an authorized item. In such a way, that item becomes part of the property record 117 and other parties may understand that the underlying information may not be reliable.

FIG. 3 describes an embodiment where if the requester does not have explicit permission to write to the property record, the item may still be written to the distributed electronic ledger if the source has satisfied one or more verification criteria or the owner of the record provides authorization. In another embodiment, if the source of the request does not have explicit permission, the request is not written to the distributed electronic ledger or it is written but marked as not being authorized.

The property record 117 may be used by the distributed electronic ledger manager service 110, the online service marketplace 120, or other entity. For instance, the information in the property record 117 may be used to track information related to the property associated with the property record 117 and take an action.

For example, item(s) that are added to the property record 117 may include information about a date (e.g., an expiration date for a warranty of a product added, an expiration date for the expected lifetime of a product, regular maintenance period of a product (e.g., 3 months, 6 months, 1 year, etc.), etc.). In an embodiment, a piece of software tracks these dates and can notify the owner of the property record 117 or other entity of an upcoming date (e.g., an upcoming expiration date, an upcoming maintenance date, etc.). The notification may also include a recommendation to replace a product if, for instance, it is nearing its expected end of life.

As another example, item(s) that are added to the property record 117 may include model numbers and/or serial numbers of products in the property. In an embodiment, a piece of software tracks manufacturer recalls based on the model number and/or serial number and can notify the owner of the property record 117 or other entity of a product recall (e.g., identifying the product that has been recalled). In an embodiment, a piece of software tracks the manufacturer's recommended actions for a product (e.g., based on model number and/or serial number) and can notify the owner of the property record 117 or other entity of the recommended action. A recommended action may include a maintenance task such as periodic maintenance. In an embodiment, the notification may include one or more service professionals that can perform such recommended action (e.g., sent by the online service marketplace 120).

The property record 117 may be read publicly according to an embodiment. For instance, the distributed electronic ledger manager service 110 or other system can create a dashboard for users to read the data of the property record 117.

If the property changes owners, the ownership of the property record 117 may be passed on from the previous owner to the current owner.

FIG. 3 shows an embodiment for determining whether the source of the request is authorized to write to the property record 117. In another embodiment, determining whether the item is authorized to be added to the property record 117 further includes determining whether the content of the item has been verified. In such an embodiment, prior to operation 220 being performed, the determination of whether the content of the item has been verified is performed. Determining whether the content of the item has been verified can be done as described elsewhere herein.

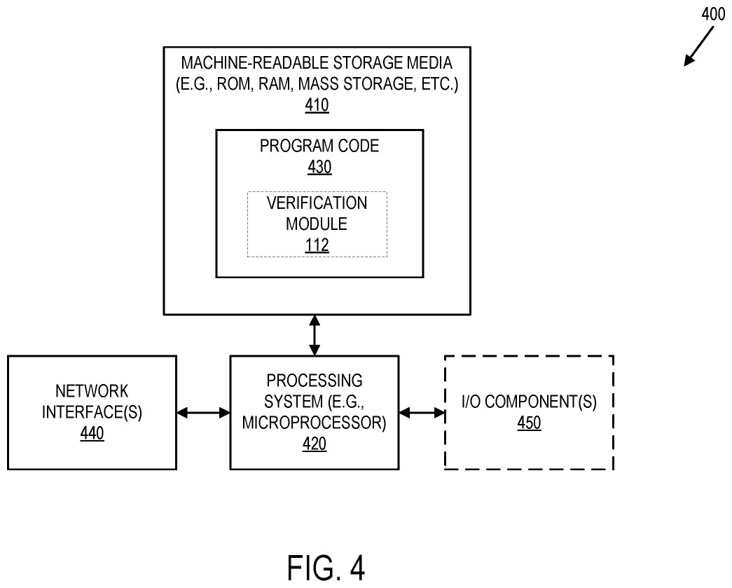

FIG. 4 illustrates a block diagram for an exemplary data processing system 400 that may be used in some embodiments. One or more such data processing systems 400 may be utilized to implement the embodiments and operations described with respect to the devices included within the distributed electronic ledger manager service 110. Data processing system 400 includes a processing system 420 (e.g., one or more processors and connected system components such as multiple connected chips).

The data processing system 400 is an electronic device that stores and transmits (internally and/or with other electronic devices over a network) code (which is composed of software instructions and which is sometimes referred to as computer program code or a computer program) and/or data using machine-readable media (also called computer-readable media), such as machine-readable storage media 410 (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals), which is coupled to the processing system 420. For example, the depicted machine-readable storage media 410 may store program code 430 that, when executed by the processor(s) 420, causes the data processing system 400 to execute the verification module 112, and/or any of the operations described herein.

The data processing system 400 also includes one or more network interfaces 440 (e.g., a wired and/or wireless interfaces) that allows the data processing system 400 to transmit data and receive data from other computing devices, typically across one or more networks (e.g., Local Area Networks (LANs), the Internet, etc.). The data processing system 400 may also include one or more input or output (“I/O”) components 450 such as a mouse, keypad, keyboard, a touch panel or a multi-touch input panel, camera, frame grabber, optical scanner, an audio input/output subsystem (which may include a microphone and/or a speaker), other known I/O devices or a combination of such I/O devices. Additional components, not shown, may also be part of the system 400, and, in certain embodiments, fewer components than that shown in One or more buses may be used to interconnect the various components shown in FIG. 4.

The techniques shown in the figures can be implemented using code and data stored and executed on one or more electronic devices (e.g., a client device, a server). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

In the preceding description, numerous specific details such are set forth to provide a more thorough understanding of the present invention. It will be appreciated, however, by one skilled in the art that the invention may be practiced without such specific details. In other instances, control structures, gate level circuits and full software instruction sequences have not been shown in detail in order not to obscure understanding. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the preceding description and the claims, the terms “coupled” and “connected,” along with their derivatives, may be used. These terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method for a verifiable property record of a property using a distributed electronic ledger, comprising:
receiving a first request to add a first item to a distributed electronic ledger, wherein the first item is related to the property;
determining that the first item is authorized to be added to the distributed electronic ledger including:
determining a first source of the first request to add the first item to the distributed electronic ledger, and
determining that the first source of the first request has explicit permission to write to the distributed electronic ledger;
responsive to determining that the first item is authorized to be added to the distributed electronic ledger, causing the first item to be added to the distributed electronic ledger;
receiving a second request to add a second item to the distributed electronic ledger, the second item related to the property;
determining that the second item is authorized to be added to the distributed electronic ledger including:
determining a second source of the second request to add the second item to the distributed electronic ledger,
determining that the second source of the second request does not have explicit permission to write to the distributed electronic ledger, and
determining that the second source of the second request has satisfied one or more verification criteria for adding the second item to the distributed electronic ledger; and
responsive to determining that the second item is authorized to be added to the distributed electronic ledger, causing the second item to be added to the distributed electronic ledger.

2. The method of claim 1, further comprising:
receiving a third request to add a third item to the distributed electronic ledger, the third item related to the property;
determining that the third item is not authorized to be added to the distributed electronic ledger including:
determining a third source of the third request to add the third item to the distributed electronic ledger,
determining that the third source of the third request does not have explicit permission to write to the distributed electronic ledger,
determining that the third source of the third request has not satisfied one or more verification criteria for adding the third item to the distributed electronic ledger; and
responsive to determining that the third item is not authorized to be added to the distributed electronic ledger, causing the third item to be added to the distributed electronic ledger and marking the third item as not being authorized.

3. The method of claim 1, further comprising:
wherein the first item includes information about an expiration date of a product of the property;
tracking the expiration date of the product of the property; and
responsive to the expiration date of the product of the property being within a threshold of a current date, transmitting a notification to an owner of the property of the expiration date of the product.

4. The method of claim 1, further comprising:
wherein the first item includes information about a model number and/or serial number of a product of the property;
determining that a manufacturer recall has been made based on the model number and/or serial number; and
transmitting a notification to an owner of the property of the manufacturer recall.

5. The method of claim 1, further comprising:
wherein the first item includes information about a model number and/or serial number of a product of the property;
determining one or more recommended actions from a manufacturer of the product based on the model number and/or serial number of the product; and
transmitting a notification to an owner of the property of the determined one or more recommended actions.

6. The method of claim 1, wherein the second request is received responsive to a service being performed by a service provider.

7. The method of claim 6, wherein the second request is received from the service provider, and wherein the one or more verification criteria includes an invoice and a photo of the completed service.

8. The method of claim 1, wherein determining that the first item is authorized to be added to the distributed electronic ledger further includes determining that content of the first item is verified as accurate.

9. A non-transitory machine-readable storage medium that provides instructions that, if executed by a processor, will cause said processor to perform operations comprising:
receiving a first request to add a first item to a distributed electronic ledger, wherein the first item is related to a property;
determining that the first item is authorized to be added to the distributed electronic ledger including:
determining a first source of the first request to add the first item to the distributed electronic ledger, and
determining that the first source of the first request has explicit permission to write to the distributed electronic ledger;
responsive to determining that the first item is authorized to be added to the distributed electronic ledger, causing the first item to be added to the distributed electronic ledger;
receiving a second request to add a second item to the distributed electronic ledger, the second item related to the property;
determining that the second item is authorized to be added to the distributed electronic ledger including:
determining a second source of the second request to add the second item to the distributed electronic ledger,
determining that the second source of the second request does not have explicit permission to write to the distributed electronic ledger, and
determining that the second source of the second request has satisfied one or more verification criteria for adding the second item to the distributed electronic ledger; and
responsive to determining that the second item is authorized to be added to the distributed electronic ledger, causing the second item to be added to the distributed electronic ledger.

10. The non-transitory machine-readable storage medium of claim 9, wherein the operations further comprise:
receiving a third request to add a third item to the distributed electronic ledger, the third item related to the property;
determining that the third item is not authorized to be added to the distributed electronic ledger including:
determining a third source of the third request to add the third item to the distributed electronic ledger,
determining that the third source of the third request does not have explicit permission to write to the distributed electronic ledger,
determining that the third source of the third request has not satisfied one or more verification criteria for adding the third item to the distributed electronic ledger; and
responsive to determining that the third item is not authorized to be added to the distributed electronic ledger, causing the third item to be added to the distributed electronic ledger and marking the third item as not being authorized.

11. The non-transitory machine-readable storage medium of claim 9, wherein the operations further comprise:
wherein the first item includes information about an expiration date of a product of the property;
tracking the expiration date of the product of the property; and
responsive to the expiration date of the product of the property being within a threshold of a current date, transmitting a notification to an owner of the property of the expiration date of the product.

12. The non-transitory machine-readable storage medium of claim 9, wherein the operations further comprise:
wherein the first item includes information about a model number and/or serial number of a product of the property;
determining that a manufacturer recall has been made based on the model number and/or serial number; and
transmitting a notification to an owner of the property of the manufacturer recall.

13. The non-transitory machine-readable storage medium of claim 9, wherein the operations further comprise, further comprising:
wherein the first item includes information about a model number and/or serial number of a product of the property;
determining one or more recommended actions from a manufacturer of the product based on the model number and/or serial number of the product; and
transmitting a notification to an owner of the property of the determined one or more recommended actions.

14. The non-transitory machine-readable storage medium of claim 9, wherein the second request is received responsive to a service being performed by a service provider.

15. The non-transitory machine-readable storage medium of claim 14, wherein the second request is received from the service provider, and wherein the one or more verification criteria includes an invoice and a photo of the completed service.

16. The non-transitory machine-readable storage medium of claim 9, wherein the operations further comprise, wherein determining that the first item is authorized to be added to the distributed electronic ledger further includes determining that content of the first item is verified as accurate.

17. An apparatus, comprising:
a processor; and
a non-transitory machine-readable storage medium that provides instructions that, if executed by the processor, will cause said processor to perform operations including:
receiving a first request to add a first item to a distributed electronic ledger, wherein the first item is related to a property;
determining that the first item is authorized to be added to the distributed electronic ledger including:
determining a first source of the first request to add the first item to the distributed electronic ledger, and
determining that the first source of the first request has explicit permission to write to the distributed electronic ledger;
responsive to determining that the first item is authorized to be added to the distributed electronic ledger, causing the first item to be added to the distributed electronic ledger;
receiving a second request to add a second item to the distributed electronic ledger, the second item related to the property;
determining that the second item is authorized to be added to the distributed electronic ledger including:
determining a second source of the second request to add the second item to the distributed electronic ledger,
determining that the second source of the second request does not have explicit permission to write to the distributed electronic ledger, and
determining that the second source of the second request has satisfied one or more verification criteria for adding the second item to the distributed electronic ledger; and
responsive to determining that the second item is authorized to be added to the distributed electronic ledger, causing the second item to be added to the distributed electronic ledger.

18. The apparatus of claim 17, wherein the operations further comprise:
receiving a third request to add a third item to the distributed electronic ledger, the third item related to the property;
determining that the third item is not authorized to be added to the distributed electronic ledger including:
determining a third source of the third request to add the third item to the distributed electronic ledger,
determining that the third source of the third request does not have explicit permission to write to the distributed electronic ledger,
determining that the third source of the third request has not satisfied one or more verification criteria for adding the third item to the distributed electronic ledger; and
responsive to determining that the third item is not authorized to be added to the distributed electronic ledger, causing the third item to be added to the distributed electronic ledger and marking the third item as not being authorized.

19. The apparatus of claim 17, wherein the operations further comprise:
wherein the first item includes information about an expiration date of a product of the property;
tracking the expiration date of the product of the property; and
responsive to the expiration date of the product of the property being within a threshold of a current date, transmitting a notification to an owner of the property of the expiration date of the product.

20. The apparatus of claim 17, wherein the operations further comprise:
wherein the first item includes information about a model number and/or serial number of a product of the property;
determining that a manufacturer recall has been made based on the model number and/or serial number; and
transmitting a notification to an owner of the property of the manufacturer recall.

21. The apparatus of claim 17, wherein the operations further comprise:
wherein the first item includes information about a model number and/or serial number of a product of the property;
determining one or more recommended actions from a manufacturer of the product based on the model number and/or serial number of the product; and
transmitting a notification to an owner of the property of the determined one or more recommended actions.

22. The apparatus of claim 17, wherein the second request is received responsive to a service being performed by a service provider.

23. The apparatus of claim 22, wherein the second request is received from the service provider, and wherein the one or more verification criteria includes an invoice and a photo of the completed service.

24. The apparatus of claim 17, wherein the operations further comprise, wherein determining that the first item is authorized to be added to the distributed electronic ledger further includes determining that content of the first item is verified as accurate.
